(19) United States
(12) Patent Application Publication
(10) Pub. No.: US 2009/0101282 A1
(43) Pub. Date: Apr. 23, 2009

(54) Apparatus and method for picking-up semiconductor dies

(75) Inventors: Noboru Fujino, Akishima-shi (JP); Okito Umehara, Tachikawa-shi (JP); Akio Katsuro, Higashimurayama-shi (JP); Shinichi Sasaki, Higashiyamato-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Kabushiki Kaisha Shinkawa

(21) Appl. No.: 12/231,706

(22) Filed: Sep. 5, 2008

(30) Foreign Application Priority Data
Sep. 6, 2007 (JP) 2007-231145

(51) Int. Cl. B07C 99/00

(52) U.S. Cl. 156/344; 156/584

(57) ABSTRACT

A die pick-up apparatus and method using a wiper that has a tip end moving in and out of an adherence surface of a die stage and a shutter that is moved with the wiper while blocking a suction window formed in the adherence surface. When picking up a semiconductor die, the tip end of the wiper is aligned with a first end of the die, the wiper is moved along the adherence surface while the tip end of the wiper is protruded from the adherence surface with the die being suction-held by a collet. A suction opening is sequentially opened between a first end surface of the suction window and a seat surface of the wiper as the wiper is moved, and a dicing sheet attached to the die is suctioned into the suction opening that has been opened and sequentially peeled off from the die.

### BACKGROUND OF THE INVENTION

The present invention relates to structures of a die pick-up apparatus for picking up semiconductor dies and to methods for picking up semiconductor dies.

Semiconductor dies are typically produced by dicing a wafer of 6 or 8 inches in diameter into dies of a predetermined size. When dicing a wafer, an adhesive dicing tape is applied on the back side of the wafer so as to prevent the produced semiconductor dies from falling apart, and then the wafer is cut from the other (front) side using, for example, a dicing saw. At this time, the dicing tape applied on the back side of the wafer is slightly cut on its surface but not entirely cut off, and the semiconductor dies are held and left on the tape. Then, the individual semiconductor dies are picked up one by one from the dicing tape and transferred to a subsequent step such as a die bonding step.

Conventionally, a method using a push-up needle is wildly employed for picking up semiconductor dies from an adhesive dicing tape (see FIG. 15 of Japanese Patent No. 3209736, for example). According to this method, semiconductor dies are picked up using a collet in such a manner that a semiconductor die is pushed upward in its center by a push-up needle under a dicing sheet on which a tensile force is exerted toward its periphery while the semiconductor die is suctioned by a collet, and thus the semiconductor die is removed from the adhesive dicing sheet by the tensile force exerted to the dicing sheet.

However, this method that uses a push-up needle has become less suitable for picking up thin semiconductor dies of recent years, because the method poses a problem that the pushing up can break the semiconductor dies as the dies become thinner.

For this reason, methods have been proposed with which semiconductor dies are removed and picked up from an adhesive dicing sheet without requiring the use of a push-up needle. For example, Japanese Patent No. 3209736 proposes a method including: placing a semiconductor die to be picked up over a suction hole in a die stage having a plurality of suction holes; producing vacuum in the plurality of suction holes to deform a dicing sheet by suctioning the sheet into the suction holes while the semiconductor die is suction-held by a collet; removing the dicing sheet corresponding to the suction hole from the semiconductor die; and then removing the remaining part of the dicing sheet from the semiconductor die by moving the die stage horizontally or rotationally (see FIG. 1 through FIG. 4 of Japanese Patent No. 3209736).

Japanese Patent No. 3209736 proposes another method. This method uses a die stage in which a protrusion is formed on a surface of the die stage, having a width narrower than that of a semiconductor die to be picked up, and a suction hole is provided in a portion of the surface of the die stage that surrounds the protrusion; and with the use of this die stage, the method takes the steps of: mounting the semiconductor die to be picked up on the protrusion when picking up the semiconductor die such that the die to be picked up sticks out of the protrusion, and moving the protrusion in parallel with the surface of the die stage while suctioning air between a dicing sheet and the surface of the die stage from the suction hole, thereby peeling the dicing sheet from the semiconductor die (see FIG. 9 and FIG. 10 of Japanese Patent No. 3209736).

The method disclosed in Japanese Patent No. 3209736 is to peel the dicing tape from the semiconductor die by producing vacuum in the suction hole to suction the dicing tape into the suction holes. However, once peeled off from the semiconductor die, the dicing tape covers the suction hole, and consequently it is not possible to suction the air around the suction hole after peeling a portion of the dicing tape immediately above the suction hole. Thus, while the portion of the dicing sheet immediately above the suction hole can be peeled off by the suctioning, a portion of the dicing sheet covering around the suction hole cannot be peeled off by the vacuum suction through the suction hole and remains adhered to the semiconductor die (see FIG. 1 and FIG. 2 of Japanese Patent No. 3209736). On the other hand, in a case in which the remaining portion of the dicing sheet is peeled off by moving the die stage, a smaller area of the remaining portion results in a smaller force exerted to the semiconductor die, thereby reducing the damage caused to the semiconductor die. However, in order to make the remaining portion after peeling off the dicing sheet through the suction hole smaller, the suction hole is required to be of a size corresponding to the size of the semiconductor die to be picked up. Suctioning the dicing sheet through such a large suction hole may, when adhesive force of the dicing sheet is large, produce a large force that is exerted to the semiconductor die, and such a large force may break or deform the semiconductor die, especially because semiconductor dies of recent years are made thin with less intensity. As described above, with the method disclosed in Japanese Patent No. 3209736, it is unable to control the force exerted to the semiconductor die during the peeling off of the dicing sheet, because a large force is applied to the semiconductor die during the suctioning when a large suction hole is used, and during the movement of the die stage when a small suction hole is used, and thus the method poses a problem that the semiconductor die can be damaged.

The other method disclosed in Japanese Patent No. 3209736 peels off the dicing sheet by suctioning the air between the dicing sheet and the surface of the die stage through a small suction hole provided only around the protrusion, and thus it is possible to control the force exerted to the semiconductor die due to the suctioning. However, in this method, as the protrusion moves, the dicing sheet that has been peeled off from the semiconductor die covers the suction hole at the portion where the protrusion moves, and thus an amount of air suctioned decreases gradually according to the movement of the protrusion (see FIG. 9 and FIG. 10 of Japanese Patent No. 3209736). On the other hand, the length of the peeling line along which the dicing sheet is peeled is determined based on the width of the protrusion that moves, the force required to peel the dicing sheet does not change according to the moving direction of the protrusion. Further, because an area of the cross section of a gap between the side of the protrusion and the dicing sheet taken vertically to the movement direction of the protrusion does not change according to the movement of the protrusion, an area of the cross section of a flow path through which the air flows into the gap due to the movement of the protrusion does not change as well. Therefore, as the suction hole is blocked by the dicing sheet along with the movement of the protrusion, the amount of the air suctioned gradually decreases, and in turn the degree of the vacuum between the protrusion and the dicing sheet is reduced, thereby gradually decreasing the peel off power. In addition, there is a case in which the semiconductor die cannot be picked up smoothly because the dicing sheet remains unpeeled on the end surface of the semiconductor die facing toward the direction in which the protrusion moves. In such a case, it is possible to increase the peeling force utilizing the tensile force exerted to the dicing sheet by increasing the height of the protrusion. However, there is a problem that the protrusion can be brought into contact with an adjacent semiconductor die to damage the semiconductor die when the adjacent semiconductor die is present in the direction in which the protrusion moves, and thus the direction in which the protrusion moves is limited.

### SUMMARY OF THE INVENTION

In view of the above problems, an object of the present invention is to provide a die pick-up apparatus and method for picking up a semiconductor die easily while controlling a force exerted to the semiconductor die during peeling off of a dicing sheet.

A die pick-up apparatus for picking up semiconductor dies according to the present invention suctions and holds a semiconductor die attached to a dicing sheet and picking up the semiconductor die using a collet, and the pick-up apparatus is comprised of:
a die stage provided with an adherence surface that is adhered to a first surface of the dicing sheet facing away from a second surface of the dicing sheet to which the semiconductor die is attached;
a wiper having a tip end, which moves in and out of the adherence surface, and a seat surface, which moves toward and away from an end surface of a suction window formed in the adherence surface; and
a shutter that moves along with the wiper while blocking the suction window in a direction in which the wiper is moved, wherein

the die pick-up apparatus, when picking up the semiconductor die,
aligns the tip end of the wiper with a first end of the semiconductor die to be picked up,
moves the wiper in a direction in which the seat surface of the wiper moving away from the end surface of the suction window while the tip end of the wiper is protruded from the adherence surface while the semiconductor die to be picked up is being suctioned by the collet, thus sequentially opening a suction opening between the end surface of the suction window and the seat surface of the wiper, and
suctions the dicing sheet from a first end side of the semiconductor die to be picked up into the suction opening that has been opened,
thereby sequentially peeling the dicing sheet from the semiconductor die to be picked up.

In the die pick-up apparatus for picking up semiconductor dies according to the present invention, it is preferable that the suction window and the wiper have substantially the same width as the semiconductor die to be picked up, and that the wiper be formed with a notch at a corner between the seat surface and a side surface thereof. It is also preferable that the die stage be provided with a suction hole formed around the suction window in the adherence surface, and when picking up the semiconductor die, the tip end of the wiper be caused to protrude from the adherence surface and move while a portion of the dicing sheet around the semiconductor die to be picked up is suctioned through the suction hole.

Further, it is preferable that the die pick-up apparatus for picking up semiconductor dies according to the present invention include a wiper moving mechanism for moving the wiper, wherein the wiper moving mechanisms is comprised of:
a drive unit that is attached to a base body of the die stage provided on a side opposite from the adherence surface and drives a first link member provided within the die stage in a direction that the first link member is moved closer to and away from the adherence surface;
a piston that is provided within the die stage and moved closer to and away from the adherence surface;
a stopper that is provided within the die stage and restricts the movement of the piston moving closer to and away from the adherence surface;
a spring that connects the first link member with the piston in the direction closer to and away from the adherence surface, the spring being compressed when the piston is brought into contact with the stopper;
a guide rail that is attached to the piston and extends in a direction which is substantially in parallel with the adherence surface and in which the suction opening extends, the wiper being slidably provided on the guide rail; and
a second link member that is slidably attached to the piston, connects the wiper with the first link member, and converts a movement of the first link member moving closer to and away from the adherence surface into a movement of the wiper moving along the guide rail when the piston is brought into contact with the stopper, wherein

when picking up the semiconductor die, the wiper is caused to slide along the adherence surface after the tip end of the wiper protrudes from the adherence surface by the first link member moving closer to and away from the adherence surface using the drive unit.

Moreover, it is preferable that the die pick-up apparatus for picking up semiconductor dies according to the present invention further include a wiper moving mechanism for moving the wiper, wherein the wiper moving mechanism is comprised of:
a drive unit that is attached to a base body of the die stage provided on a side opposite from the adherence surface and drives a first link member provided within the die stage in a direction that the first link member is moved closer to and away from the adherence surface;
a guide rail that is provided within the die stage and is formed with an inclined surface that inclines toward the adherence surface;
a slider to which the wiper is connected and which is provided slidably along the inclined surface of the guide rail; and
a second link member that is slidably provided within the die stage, connects the slider to the first link member, and converts a movement of the first link member moving closer to and away from the adherence surface into a movement of the slider moving along the inclined surface of the guide rail, and wherein

when picking up the semiconductor die, the wiper is caused to slide along the adherence surface while the tip end of the wiper protrudes from the adherence surface by the first link member moving closer to the adherence surface using the drive unit.

Furthermore, it is preferable that the die pick-up apparatus for picking up semiconductor dies according to the present invention include a wiper moving mechanism for moving the wiper, wherein the wiper moving mechanism is comprised of:
a drive unit that is attached to a base body of the die stage provided on a side opposite from the adherence surface, and drives a first link member provided within the die stage in a direction that the first link member is moved closer to and away from the adherence surface;
a guide rail that is provided within the die stage and is formed with a first sliding surface in a direction facing away from the adherence surface and a second sliding surface in a direction facing toward the adherence surface;
a slider to which the wiper is connected and which is provided slidably in each direction along each sliding surface of the guide rail; and
a second link member that is slidably provided within the die stage via an elongate hole that extends by a length of a first sliding surface thereof in the direction closer to and away from the adherence surface, and converts a movement of the first link member moving closer to and away from the adherence surface into a movement along each sliding surface, and wherein

when picking up the semiconductor die, the wiper is caused to slide along the adherence surface while the tip end of the wiper protrudes from the adherence surface by the first link member moving closer to the adherence surface using the drive unit.

A method for picking up semiconductor dies according to the present invention picks up semiconductor dies that are attached to a dicing sheet using a die pick-up apparatus that is comprised of:
a die stage provided with an adherence surface that is adhered to a first surface of the dicing sheet facing away from a second surface of the dicing sheet to which a semiconductor die to be picked up is attached;
a wiper having a tip end that moves in and out of the adherence surface and a seat surface that moves away from an end surface of a suction window formed in the adherence surface;
a shutter that is moved with the wiper while blocking the suction window in a direction in which the wiper is moved; and
a collet for picking up the semiconductor die, and

the method comprises:
a positioning step in which the tip end of the wiper is aligned with a first end of the semiconductor die to be picked up; and
a dicing sheet peeling step in which
   the wiper is moved in a direction in which the seat surface of the wiper is moved away from the end surface of the suction window while the tip end of the wiper is protruded from the adherence surface in a state in which the semiconductor die to be picked up is suctioned by the collet,
   a suction opening is sequentially opened between the end surface of the suction window and the seat surface of the wiper, and
   the dicing sheet is suctioned from a first end side of the semiconductor die to be picked up into the suction opening that has been opened,
   thereby sequentially peeling the dicing sheet from the semiconductor die to be picked up.

The present invention advantageously provides a die pick-up apparatus and method for picking up semiconductor dies capable of picking up a semiconductor die easily while controlling a force exerted to the semiconductor die during peeling off of a dicing sheet attached to the die.

### BRIEF DESCRIPTION OF THE DRAWINGS

FIG. 1 is an explanatory diagram illustrating a wafer on a dicing sheet;

FIG. 2 is an explanatory diagram illustrating semiconductor dies on the dicing sheet;

FIGS. 3(a) and 3(b) are explanatory diagrams illustrating a configuration of a wafer holder;

FIG. 4 is an explanatory diagram illustrating a configuration of a die pick-up apparatus for picking up semiconductor dies of one embodiment according to the present invention;

FIG. 5 is a perspective view illustrating a die stage of the die pick-up apparatus for picking up semiconductor dies of the embodiment according to the present invention;

FIGS. 6(a) and 6(b) are explanatory diagrams illustrating a state of the die pick-up apparatus for picking up semiconductor dies of the embodiment according to the present invention before a wiper of the die pick-up apparatus starts moving;

FIGS. 7(a) and 7(b) are explanatory diagrams illustrating a state of the die pick-up apparatus for picking up semiconductor dies of the embodiment according to the present invention when the wiper of the die pick-up apparatus starts moving;

FIGS. 8(a) and 8)b) are explanatory diagrams illustrating a state of the die pick-up apparatus for picking up semiconductor dies of the embodiment according to the present invention while the wiper of the die pick-up apparatus keeps moving;

FIGS. 9(a) and 9(b) are explanatory diagrams illustrating a state of the die pick-up apparatus for picking up semiconductor dies of the embodiment according to the present invention when the wiper of the die pick-up apparatus finishes moving;

FIGS. 10(a) and 10(b) are explanatory diagrams illustrating a state of the die pick-up apparatus for picking up semiconductor dies of the embodiment according to the present invention when a collet of the die pick-up apparatus picks up a semiconductor die and the wiper returns to an initial position;

FIGS. 11(a) and 11(b) are explanatory diagrams illustrating a configuration of a die pick-up apparatus for picking up semiconductor dies of a different embodiment according to the present invention;

FIG. 12 is an explanatory diagram illustrating a configuration of a die pick-up apparatus for picking up semiconductor dies of a different embodiment according to the present invention;

FIG. 13 is an explanatory diagram illustrating a state of the die pick-up apparatus for picking up semiconductor dies of the different embodiment according to the present invention in which a wiper of the die pick-up apparatus protrudes from an adherence surface;

FIG. 14 is an explanatory diagram illustrating a state of the die pick-up apparatus for picking up semiconductor dies of the different embodiment according to the present invention in which the wiper of the die pick-up apparatus is moved along the adherence surface;

FIG. 15 is an explanatory diagram illustrating a configuration of a die pick-up apparatus for picking up semiconductor dies of a further different embodiment according to the present invention;

FIG. 16 is an explanatory diagram illustrating a state of the die pick-up apparatus for picking up semiconductor dies of the further different embodiment according to the present invention in which a wiper of the die pick-up apparatus protrudes from an adherence surface; and

FIG. 17 is an explanatory diagram illustrating a state of the die pick-up apparatus for picking up semiconductor dies of the further different embodiment according to the present invention in which the wiper of the die pick-up apparatus is moved along the adherence surface.

### DETAILED DESCRIPTION OF THE INVENTION

The preferred embodiments of the present invention will be described in detail below with reference to the accompanying drawings. Before describing a die pick-up apparatus for picking up semiconductor dies according to the present invention, an explanation will be given first on a wafer and a wafer holder.

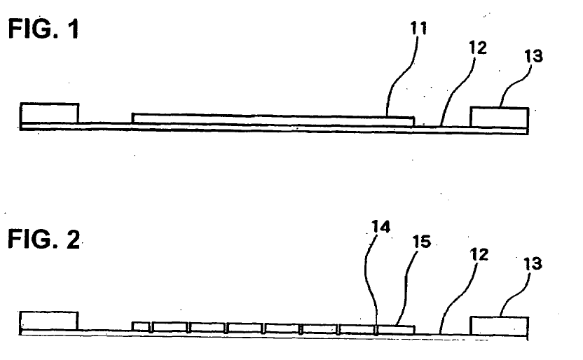

Referring to FIG. 1, a wafer 11 is applied with an adhesive dicing sheet 12 on a back side thereof, and the dicing sheet 12 is attached to a metal ring 13. The wafer 11 is handled while being attached to the metal ring 13 with the dicing sheet 12 therebetween as shown in the drawings. Then, as shown in FIG. 2, the wafer 11 is diced, in a dicing step, into semiconductor dies 15 from the other side using, for example, a dicing saw. Between each pair of the semiconductor dies 15 is a cutting gap 14 that is formed during the dicing, and while the cutting gap 14 reaches a part of the dicing sheet 12 through the semiconductor dies 15, the dicing sheet 12 is not totally cut apart, and the semiconductor dies 15 remain held on the dicing sheet 12.

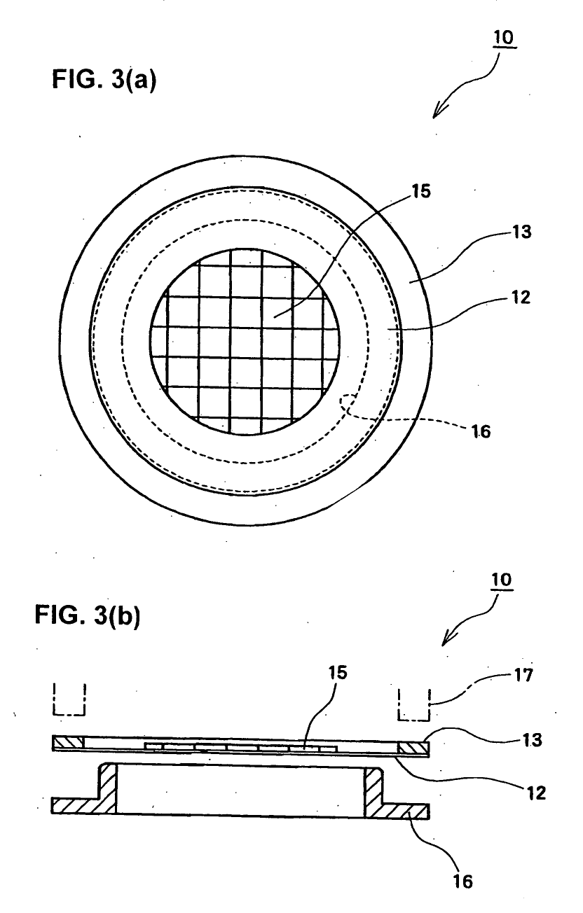

The semiconductor dies 15 attached to the dicing sheet 12 and the ring 13 in this manner is mounted on a wafer holder 10 as shown in FIGS. 3A and 3B. The wafer holder 10 is provided with an annular expand ring 16 having a flange portion and ring retainers 17 that retain the ring 13 on the flange of the expand ring 16. The ring retainers 17 are driven close to and away from the flange of the expand ring 16 by a ring retainer drive unit that is not shown in the drawings. The inner diameter of the expand ring 16 is larger than the diameter of the wafer that includes the semiconductor dies 15, and the expand ring 16 has a predetermined thickness. The flange is on the outer circumference of the expand ring 16, and it faces away form the dicing sheet so to protrudes outwardly from the end surface of the expand ring 16. Further, the outer circumference of the expand ring 16 that is on the dicing sheet side is configured to have a curved surface so that it is possible to expand the dicing sheet 12 when the dicing sheet 12 is attached to the expand ring 16. Moreover, the wafer holder 10 is configured to move along the surface of the dicing sheet 12 by a wafer holder horizontal drive unit that is not shown in the drawings.

As shown in FIG. 3(b), the dicing sheet 12 to which the semiconductor dies 15 are attached is substantially flat, before being set in the expand ring 16.

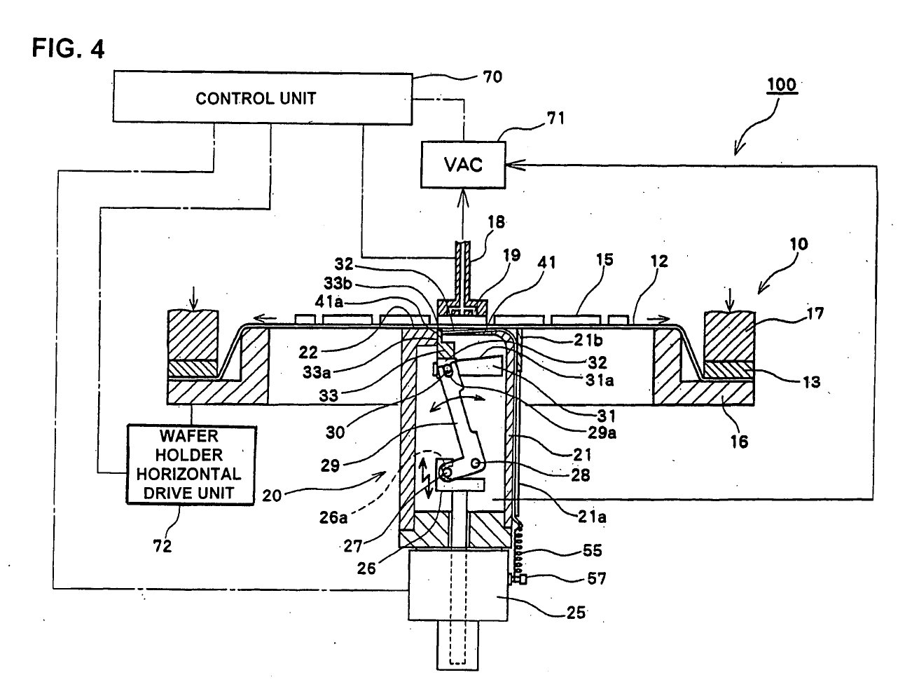

FIG. 4 is a diagram illustrating a configuration of a die pick-up apparatus 100 for picking up semiconductor dies, and it also illustrates a state in which the semiconductor dies 15 attached to the dicing sheet 12 is set in the die pick-up apparatus 100. In this state, the ring retainers 17 are lowered toward the ring 13 to hold the ring 13 between the retainers 17 and the flange of the expand ring 16. There is a difference in level or height between the upper surface of the expand ring 16 that is in contact with the dicing sheet 12 and the surface of the flange. Accordingly, when the ring 13 is pressed onto the surface of the flange, the dicing sheet 12 is stretched along the curved surface at the upper portion of the expand ring due to the height difference. As a result, a tensile force is exerted to the dicing sheet 12, which is fixed on the expand ring 16, radially from the center of the dicing sheet 12 toward the circumference. In addition, because the dicing sheet 12 is stretched due to the tensile force, the gap between the semiconductor dies 15 that are next to each other and attached to the dicing sheet 12 is also expanded.

The wafer holder 10 is attached with a wafer holder horizontal drive unit 72 that moves the wafer holder along a plane that corresponds to the dicing sheet. The wafer holder horizontal drive unit 72 drives the wafer holder 10 horizontally using, for example, a motor and a gear provided internally, and it can be one that moves the wafer holder 10 in an XY direction by a driving source which is an externally provided motor. Furthermore, a collet 18 is provided on the upper portion of the wafer holder 10 for moving the semiconductor dies 15 while suctioning. The collet 18 is provided, on its suction surface, with suction holes 19 for suctioning a semiconductor die 15, and each suction hole 19 is connected to a vacuum apparatus 71. Moreover, a die stage 20 is provided under the wafer holder 10. The die stage 20 is driven upward and downward, i.e. in a direction moving close to and away from the dicing sheet 12, by a die stage vertical drive mechanism that is not shown in the drawings.

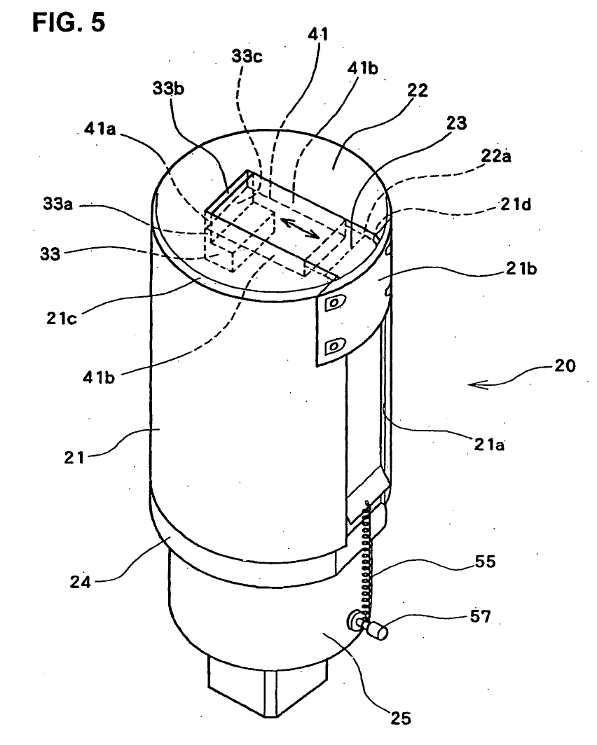

Referring to FIG. 5, the die stage 20 is comprised of a cylindrical housing 21 having on its upper surface an adherence surface 22 to which the dicing sheet 12 is adhered, a base body 24 that is provided on an opposite side of the housing 21 from the adherence surface 22, and a drive unit 25 that is attached to the base body 24 and drives a link mechanism provided inside the housing 21. The base body 24 of the die stage 20 is attached to a die stage fixing unit, not shown in the drawings, of the die pick-up apparatus.

An upper plate 21c of the housing 21 including the adherence surface 22 of the die stage 20 has a rectangular suction window 41 that penetrates through the upper plate 21c. The width of the suction window 41 is the same as that of the semiconductor die to be picked up, and a wiper 33 having the same width as the suction window 41 is provided inside the suction window 41. The wiper 33 is includes a seat surface 33a that is in contact with a first end surface 41a of the suction window 41. The seat surface 33a is configured such that it moves closer to and away from the first end surface 41a of the suction window 41. The wiper 33 further includes a tip end 33b that comes in and out of the adherence surface 22. The tip end 33b of the wiper 33 is linear shape and is configured so as to be in the same plane as the adherence surface 22 when the seat surface 33a of the wiper 33 is in contact with the first end surface 41a of the suction window 41.

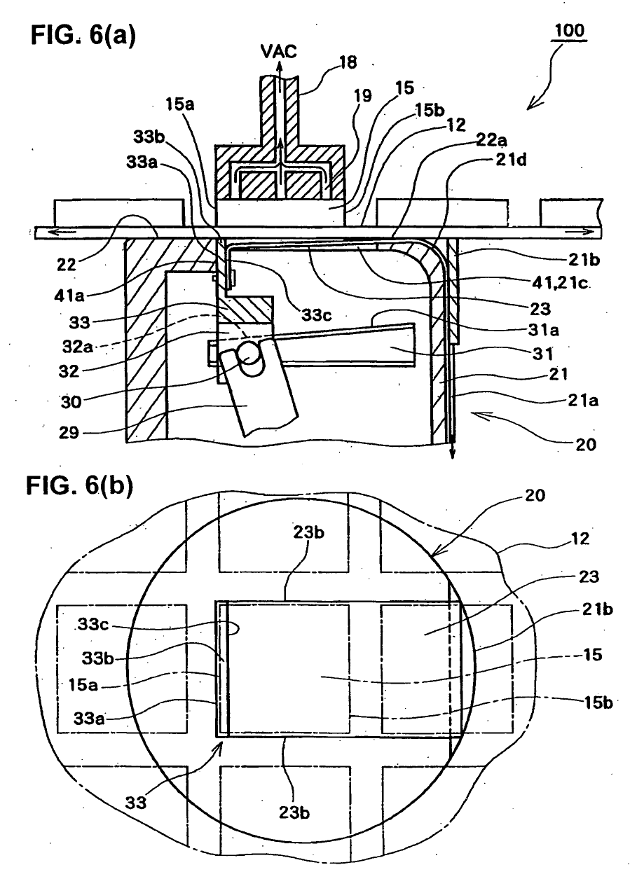

The die stage 20 is further provided with a shutter 23 that blocks, while moving together with the wiper 33, the suction window 41 in a direction in which the wiper 33 is moved. A first end of the shutter 23 is, as best seen from FIG. 6(a), attached to the moving side surface 33c which is on the opposite side from the seat surface 33a of the wiper 33. The shutter 23 is attached at its first end to the moving side surface 33c so as to be staged from (or so as to be lower than) the tip end 33b of the wiper 33. The shutter 23 is as wide as the suction window 41 and extends from the moving side surface 33c toward the direction to which the wiper 33 is moved. The shutter 23 is, as seen from FIG. 5, guided by the side surfaces 41b of the suction window 41 and by a groove 22a that is provided in the upper plate 21c on a second end side of the suction window 41 and is as wide as the suction window 41. Further, the shutter 23 is flexed toward the side surface of the die stage 20 from the direction of the adherence surface 22 at the gap between a curved surface 21d that continues from the groove 22a and a shutter retainer 21b that is provided on an outer circumference of the die stage 20, and the shutter 23 extends toward the base body 24 by being guided by the grooves 21a that is provided on the side surface of the die stage 20 and has a width which is the same as the suction window 41. The shutter 23 is connected via a spring 55 to a pin 57 provided on the outside of the drive unit 25 that is attached to the base body 24, so that the shutter 23 receives a tensile force of the spring 55. The shutter 23 is made of a flexible material such as a thin metal plate.

As shown in FIG. 4, a wiper moving mechanism for moving the wiper 33 is provided within the die stage 20. The slide mechanism is comprised of: a first link member 26 that is driven in a direction closer to and away from with respect to the adherence surface 22 by a drive unit 25 mounted to the base body 24 of the die stage 20; a second link member 29 in a L-shape and attached rotatably to a pin 28 fixed to the housing 21; a pin 27 provided at a first end of the second link member 29 and fitted to an engaging groove 26a of the first link member 26 so as to connect the first link member 26 and the second link member 29; a guide rail 31 fixed to the housing 21 and provided with an inclined surface 31a that downwardly inclines toward the adherence surface 22; a slider 32 which with the wiper 33 attached thereto slides along the inclined surface 31a of the guide rail 31; and a pin 30 attached to the slider 32 and fitted in an U-shaped engaging groove 29a formed in a second end of the second link member 29 so as to connect the slider 32 and the second link member 29.

The slider 32 is provided with an inclined surface 32a that slides on and contacts with the inclined surface 31a of the guide rail 31.

Further, the housing 21 is connected to the vacuum apparatus 71 so as to be evacuated to produce a vacuum therein. The drive unit 25 can have any configuration as long as the first link member 26 is operated to move closer to and away from the adherence surface 22. For example, the drive unit 25 can use a small motor and a cam working in combination to drive the first link member 26 up and down, and it can directly move the first link member 26 up and down by an electromagnetic force.

Referring to FIG. 4, the operation of the slide mechanism will be described below. When the first link member 26 is moved upward toward the adherence surface 22 of the die stage 20 by the drive unit 25, the engaging groove 26a of the first link member 26 is also moved upward toward the adherence surface 22. Then, when the engaging groove 26a is move upward, the pin 27 fitted in the engaging groove 26a is moved upward along with the engaging groove 26a. When the pin 27 is thus moved upward, the second link member 29 that has the pin 27 rotates about the pin 28 fixed to the housing 21; as a result, the engaging groove 29a at the second end of the second link member 29 is moved toward a direction away from the first end surface 41a of the suction window 41. With this movement of the engaging groove 29a of the second link member 29, the pin 30 fitted in the engaging groove 29a is also moved toward the direction away from the first end surface 41a of the suction window 41. Because the slider 32 having the pin 30 is provided so as to move or slide along the inclined surface 31a of the guide rail 31 with the inclined surface 32a of the slider 32 contacting with the inclined surface 31a, when the pin 30 is moved toward the direction away from the first end surface 41a of the suction window 41 (or to the right in FIG. 4), the slider 32 moves or slides along the guide rail 31 in the direction away from the first end surface 41a of the suction window 41 and also moves or slides upward toward the adherence surface 22 along the inclined surface 31a. Then, when the slider 32 is moved along the inclined surface 31a of the guide rail 31, the wiper 33 attached to the slider 32 is moved with the slider 32 along the inclined surface 31a of the guide rail 31 upward toward the adherence surface 22 and in the direction away from the first end surface 41a of the suction window 41. When the first link member 26 is moved downward in a direction away from the adherence surface 22 by the drive unit 25, the second link member 29 and the slider 32 are moved in an opposite direction as described above, and the seat surface 33a of the wiper 33 is moved toward the first end surface 41a of the suction window 41 (or to the left in FIG. 4).

As seen from the above, the wiper moving mechanism converts, using the L-shaped second link member 29, the movement of the first link member 26 that operates in the direction closer to and away from the adherence surface 22 into the movement of the slider 32 that is moved along the inclined surface 31a of the guide rail 31. Accordingly, it is possible to configure the slide mechanism in a compact form to be accommodated within the housing 21 of a cylindrical shape.

As shown in FIG. 4, the die pick-up apparatus 100 for picking up semiconductor dies is provided with a control unit 70 that includes, among others, a CPU (Central Processing Unit). The drive unit 25, the vacuum apparatus 71, the collet 18, and the wafer holder horizontal drive unit 72 are connected to the die pick-up apparatus 100, and the drive units 25 and 72, the collet 18, and the vacuum apparatus 71 are respectively driven according to the instructions outputted from the control unit 70. In FIG. 4, single dashed lines represent signal lines connecting the control unit 70 with the drive units 25 and 72, the collet 18, and the vacuum apparatus 71, respectively. In addition, the die stage vertical drive mechanism that is not shown in the drawings is also connected to the control unit 70 and configured to drive the die stage 20 up and down according to the instruction from the control unit 70.

Now, referring to FIG. 6(a) through FIG. 10(b), the operation of picking up the semiconductor dies 15 from the dicing sheet 12 using the die pick-up apparatus 100 for picking up semiconductor dies will be described. The elements described with reference to FIG. 1 through FIG. 5 are designated by the same reference numerals and will not be explained here.

The control unit 70 starts a die positioning step. At the start of the positioning step, as shown in FIG. 6(a), the seat surface 33a of the wiper 33 provided in the die stage 20 is in contact with the first end surface 41a of the suction window 41, and the tip end 33b of the wiper 33 is in the same plane as the adherence surface 22 of the die stage 20. Further, the shutter 23 that is attached to the moving side surface 33c of the wiper 33 with a die stage from (or at a position lower than) the tip end 33b blocks the suction window 41 that extends in the moving direction of the wiper 33. The shutter 23 is as wide as the suction window 41, and the surface of a side connected to the moving side surface 33c of the wiper 33 is lower than the adherence surface 22 by a thickness of the upper plate 21c, and the surface of the shutter retainer 21 side is fitted in the groove 22a having the same width as the suction window 41 and substantially in the same plane as the adherence surface 22. Further, the shutter 23 is flexed toward a direction away from the adherence surface 22 from the groove 22a along the curved surface 21d and guided by the groove 21a of the die stage 20 and pulled downward by the spring 55 shown in FIG. 5.

The control unit 70 moves the wafer holder 10 in the parallel direction above a waiting position of the die stage 20 by the wafer holder horizontal drive unit 72 shown in FIG. 4. Then, the control unit 70 temporarily stops the parallel movement of the wafer holder 10 when the wafer holder 10 reaches a predetermined position on the waiting position of the die stage 20, and then the control unit 70 moves the die stage 20 upward by the die stage vertical drive mechanism that is not shown in the drawings until the adherence surface 22 of the die stage 20 and the upper surface of the cover plate 23 are closely in contact with the lower surface of the dicing sheet 12. Once the adherence surface 22 of the die stage 20 and the upper surface of the cover plate 23 are closely contacted to the lower surface of the dicing sheet 12, the control unit 70 stops the upward movement of the die stage 20. Then, the control unit 70 adjusts a parallel position of the wafer holder 10 using again the wafer holder horizontal drive unit 72 so that the first end surface 23a of the cover plate 23 that faces the interior of the die stage reaches a position aligning with a first end 15a of the semiconductor die 15 to be picked up. Further, the control unit 70 adjusts the side surface of the semiconductor dies 15 to align with the side surface 23b of the cover plate 23. Because the cover plate 23 is substantially as wide as the semiconductor die 15 to be picked up, aligning one of the side surfaces 23b of the cover plate 23 with the side surface of the semiconductor dies 15 realizes the alignment between the both side surfaces of the semiconductor dies 15 and both of the side surfaces 23b of the cover plate 23. When die positioning is made as described above, the dicing sheet 12 is applied with a tensile force by the expand ring 16 of the wafer holder 10.

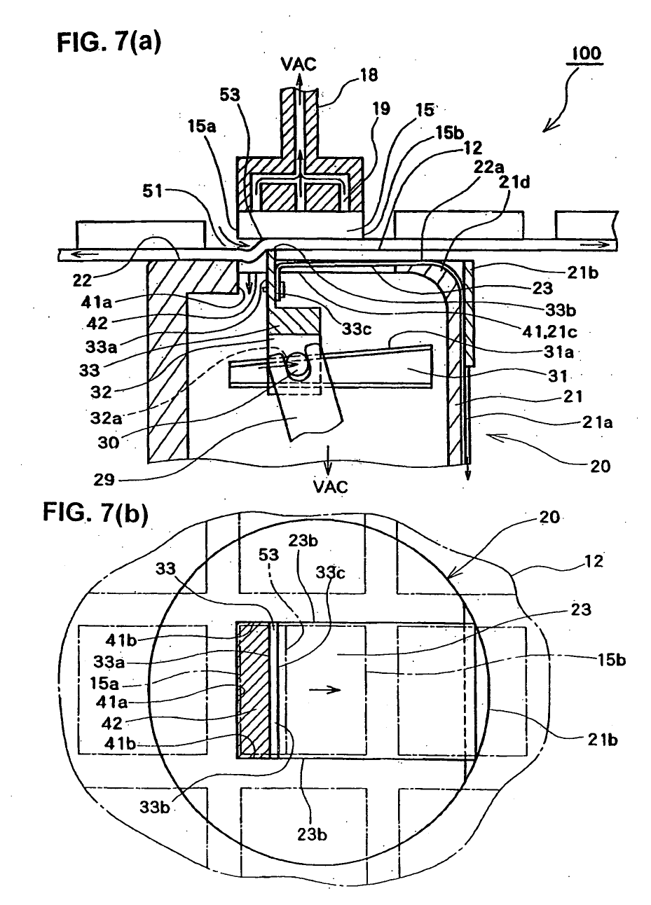

FIG. 6(b) is a plan view illustrating the adherence surface 22 of the die stage 20 and the upper surface of the cover plate 23, in which the dicing sheet 12 and the semiconductor dies 15 mounted thereon are shown by single dashed lines to clarify the positional relation. In FIG. 6(b), in order to distinguish between the semiconductor dies 15 and the cover plate 23 whose widths are both substantially the same, the cover plate 23 is shown slightly larger than the semiconductor dies 15. The same applies to FIG. 7(b) through FIG. 10(b).

As shown in FIG. 6(b), upon completion of the approach and contact of the die stage 20 to the lower surface of the dicing sheet and the positioning of the semiconductor dies 15, the control unit 70 finishes the positioning step. Upon completion of the positioning step, the semiconductor dies 15 is at a position at which the first end 15a of the semiconductor dies 15 aligns with the linear tip end 33b of the wiper 33, and side surfaces of the semiconductor dies 15 align with the side surfaces 23b of the shutter 23, respectively. Further, the second end 15b of the semiconductor dies 15 is at the position mounted on the shutter 23.

Then, the control unit 70 moves the collet 18 to above the semiconductor 15 die to be picked up and activates the vacuum apparatus 71 to evacuate the suction holes 19 on the suction surface to produce a vacuum in the holes, thereby suctioning and holding the semiconductor die 15 to be picked up at this place.

As shown in FIG. 7(a) through FIG. 10(b), the control unit 70 starts a dicing sheet peeling step. As shown in FIGS. 7(a) and 7(b), the control unit 70 evacuates the housing 21 of the die stage 20 using the vacuum apparatus 71 to produce a vacuum therein. Then, the control unit 70 moves the first link member 26 toward the adherence surface 22 using the drive unit 25. With this movement, the wiper moving mechanism is activated, and as a result the wiper 33 attached to the slider 32 is moved along the inclined surface 31a of the guide rail 31 with the slider 32 upward toward the adherence surface 22 as well as toward the direction away from the first end surface 41a of the suction window 41. As a result, the tip end 33b of the wiper 33 protrudes from the adherence surface 22 (due to the inclined surface 31a of the guide rail 31) and the seat surface 33a of the wiper moves toward the direction away from the first end surface 41a of the suction window 41. In addition, the shutter 23 is moved with the movement of the wiper 33.

As shown in FIGS. 7(a) and 7(b), when the seat surface 33a of the wiper 33 is separated from the first end surface 41a of the suction window 41, a suction opening 42 that communicates with the interior of the housing 21 and has the same width as the suction window 41 is formed between the first end surface 41a of the suction window 41 and the seat surface 33a of the wiper 33. The suction opening 42 is, as described above, as wide as the semiconductor die 15 to be picked up. The interior of the housing 21 is maintained in a vacuum state by the vacuum apparatus 71, and therefore the suction opening 42 attempts to peel the dicing sheet 12 from the semiconductor dies 15 by suctioning the dicing sheet 12 with the width of the semiconductor dies 15. In addition, because the semiconductor die 15 is pushed up from the adherence surface 22 by the tip end 33b of the wiper 33, a tensile force obliquely downward due to a tensile force that is applied radially from the center of the dicing sheet 12 is exerted to the dicing sheet 12. With this suction force and a downward component force of the tensile force, the dicing sheet 12 starts to come off from the first end 15a side of the semiconductor die 15. When the dicing sheet 12 is peeled from the first end 15a side of the semiconductor die 15, the air comes into the gap 51 between the semiconductor die 15 and the dicing sheet 12 that is produced by the peeling. As a result, a difference in pressure is produced in the dicing sheet 12 between the semiconductor die 15 side and the suction opening 42 side that has been evacuated, and thus the dicing sheet 12 is further suctioned into the suction opening 42 in the vacuum state. Then, the air comes into until it reaches a peel off line 53 that is substantially in parallel with the tip end 33b of the wiper 33, and the dicing sheet 12 is peeled off from the first end 15a side of the semiconductor die 15 up to the peel off line 53.

During the above-described process, the shutter 23 is moved away from the suction window 41 by the movement of the wiper 33. As the tip end 33b of the wiper 33 makes the movement to protrude from the adherence surface 22, the connecting end of the shutter 23 to the moving side surface 33c of the wiper 33 is also moved up to a position that is slightly lower than the adherence surface 22. Further, the surface of the shutter 23 that is fitted in the groove 22a remains substantially in the same plane as the adherence surface 22. The shutter 23 is pulled by the spring 55 shown in FIG. 5, maintains a substantially flat plane between the moving side surface 33c of the wiper 33 and the curved surface 21d of the housing 21, and blocks the suction window 41 in the direction to which the wiper 33 is moved. Accordingly, the air does not enter into the housing 21 of vacuum state through the suction window 41 that is blocked by the shutter 23, and even when a gap is formed between the shutter 23 and the dicing sheet 12 due to the semiconductor die 15 being pushed up by the tip end 33b of the wiper 33, the air in the gap is not suctioned into the suction window 41. As a result, a portion of the semiconductor die 15, which is from the tip end 33b of the wiper 33 in the direction to which the wiper 33 is moved is not suctioned into the suction window 41, and thus a possibility of, for example, deformation in the die due to the suction force is reduced.

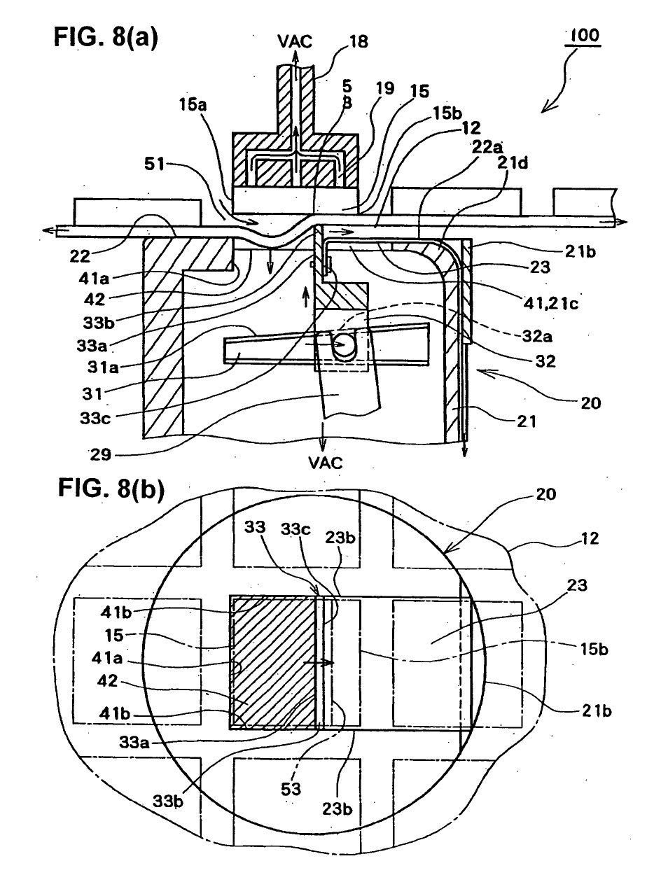

As shown in FIGS. 8(a) and 8(b), as the wiper 33 is further moved toward the direction away from the first end surface 41a of the suction window 41 according to an instruction of the control unit 70, the distance between the seat surface 33a of the wiper 33 and the first end surface 41a of the suction window 41 becomes larger, and the suction opening 42 also becomes larger. As a result, the dicing sheet 12 is sequentially suctioned into the suction opening 42 to be peeled off from the semiconductor die 15 to be picked up by the suctioning, and the peel off line 53 shifts sequentially toward the direction away from the first end surface 41a of the suction window 41 along with the movement of the tip end 33b of the wiper 33. The tip end 33b of the wiper 33 sequentially moves away from the first end surface 41a of the suction window 41 as the wiper 33 is moved, and the protrusion of the tip end 33b of the wiper 33 from the adherence surface 22 becomes sequentially larger to push the semiconductor die 15 upward. Accordingly, even if the wiper 33 is moved away from the first end surface 41a of the suction window 41, an obliquely downward angle of the dicing sheet 12 with respect to the semiconductor die 15 does not become too obtuse. Moreover, because the tensile force acting from the center of the dicing sheet 12 radially toward the outside does not change even if the wiper 33 is moved, the downward component force of the tensile force acting from the center of the dicing sheet 12 radially toward the outside does not change too much, and the force pulling the dicing sheet 12 downward can be maintained substantially constant. Further, even if the suction opening 42 is covered by the dicing sheet 12 that has been peeled off, the tip end 33b of the wiper 33 keeps moving toward a portion where the dicing sheet 12 is not peeled off, the suction of the dicing sheet 12 through the suction opening 42 is not interrupted. Therefore, the force to peel off the dicing sheet 12 does not decrease by the movement of the wiper 33, and an entirety of the dicing sheet 12 under the semiconductor die 15 to be picked up can be sequentially peeled off by being suctioned into the suction opening 42 without leaving an unpeeled portion.

Further, the shutter 23 is further moved away from the suction window 41 with the movement of the wiper 33, and the connecting end of the shutter 23 to the moving side surface 33c of the wiper 33 moves up to a level substantially in the same plane as the adherence surface 22. Because the shutter 23 is pulled by the spring 55 shown in FIG. 5, the surface of the shutter 23 corresponding to the groove 22a is maintained substantially in the same plane as the adherence surface 22. As in the case of the shutter 23 shown in FIGS. 7(a) and 7(b), since the shutter 23 blocks the suction window 41 in the direction to which the wiper 33 is moved, the air does not enter into the housing 21, which is under the vacuum state, through the suction window 41 that is blocked by the shutter 23, and a portion of the semiconductor die 15 in the direction to which the wiper 33 is moved from the tip end 33b of the wiper 33 is not suctioned into the suction window 41, and thus a possibility of, for example, deformation in the die due to the suction force is reduced.

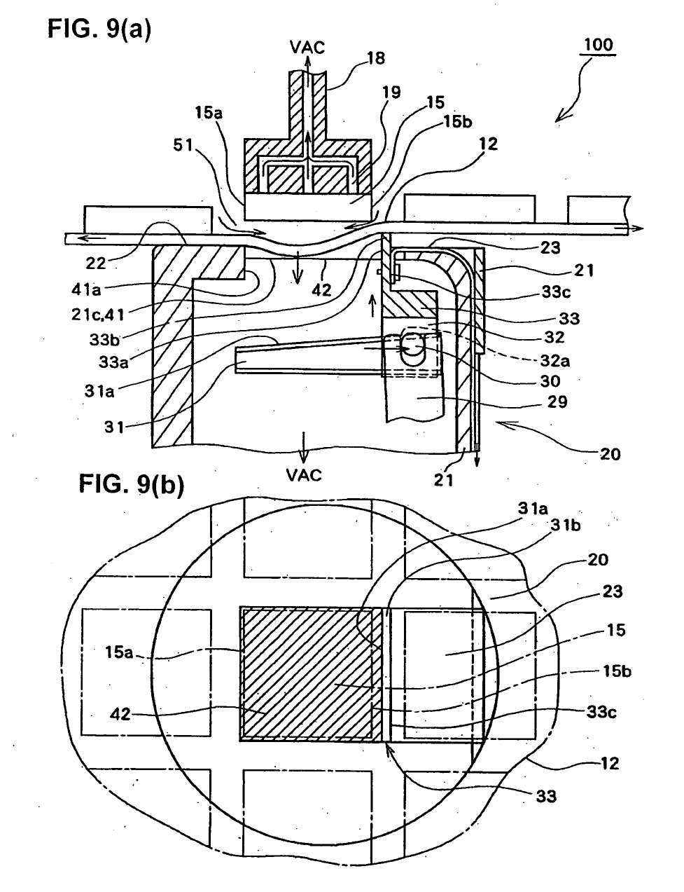

As shown in FIGS. 9(a) and 9(b), the control unit 70 moves the wiper 33 further toward the direction away from the first end surface 41a of the suction window 41 using the drive unit 25 shown in FIG. 4 to a position at which the tip end 33b of the wiper 33 passes the second end 15b of the semiconductor dies 15. As a result, the dicing sheet 12 at the second end 15b of the die 15 is suctioned into the suction opening 42 and peeled off from the semiconductor dies 15, and the air comes into between the semiconductor die 15 to be picked up and the dicing sheet 12 from the second end 15b side. Thus, the semiconductor dies 15 are completely removed from the dicing sheet 12.

Further, the shutter 23 is further moved away from the suction window 41 along with the movement of the wiper 33, and the connecting end of the shutter 23 to the moving side surface 33c of the wiper 33 moves up to a level substantially in the same plane as the adherence surface 22, and substantially in the same plane as the surface of the shutter 23 corresponding to the groove 22a. As the shutter 23 blocks the suction window 41 in the direction to which the wiper 33 is moved, the air does not enter into the housing 21, which is under the vacuum state, through the suction window 41 that is blocked by the shutter 23, and a portion of the semiconductor die 15 in the direction to which the wiper 33 is moved from the tip end 33b of the wiper 33 is not suctioned into the suction window 41, and thus a possibility of, for example, deformation in the die due to the suction force is reduced.

After this operation, because the suction opening 42 does not increase its size anymore when the wiper 33 is stopped to move, the dicing sheet 12 covers the suction opening 42 in a state that the wiper 33 is stopped to move, resulting in a state that the air around the suction opening 42 cannot be suctioned through the suction opening 42.

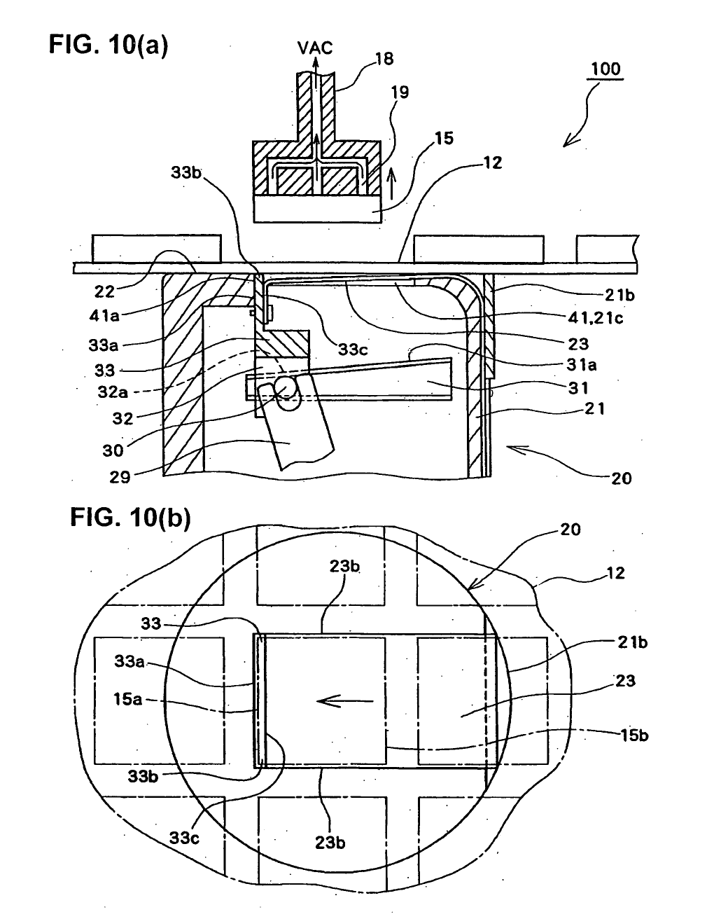

As shown in FIGS. 10(a) and 10(b), the control unit 70 then moves up the semiconductor die 15 to be picked up suctioned by the collet 18 and transports the semiconductor die 15 to a succeeding step. Then, the control unit 70 disconnects between the housing 21 and the vacuum apparatus 71 to resume the housing 21 to an atmospheric pressure, and as a result, the dicing sheet 12 returns to its original flat state due to the tensile force toward acting its circumference. The control unit 70 uses the drive unit 25 to move down the first link member 26 described with reference to FIG. 4, moves the slider 32 with the second link member 29, and further moves the seat surface 33a of the wiper 33 toward the first end surface 41a of the suction window 41. Then, the control unit 70 stops the drive unit 25 when the seat surface 33a of the wiper 33 is brought into contact with the first end surface 41a of the suction window, and the suction opening 42 is closed by the drive unit 25. In the closed state, the tip end 33b of the wiper 33 is in the same plane as the adherence surface 22.

As described above, in this embodiment, the wiper 33 is moved from the first end 15a side of the semiconductor die 15 toward the second end 15b side while the tip end 33b of the wiper 33 is protruded from the adherence surface 22 to open the suction opening 42. Accordingly, the dicing sheet 12 is peeled off by a substantially constant force pulling the dicing sheet 12 downward and by the suction force acting through the suction opening 42, and it is advantageously possible to peel off the dicing sheet 12 easily. Further, even if the suction opening 42 is covered by the dicing sheet 12 that has been peeled off, the tip end 33b of the wiper 33 is moved toward a portion where the dicing sheet 12 is not peeled yet, the suctioning of the dicing sheet 12 into the suction opening 42 never stops, and it is possible to sequentially suction the entirety of the dicing sheet 12 into the suction opening 42, thus completely removing the dicing sheet 12 without remaining.

Moreover, an area of the dicing sheet 12 to be peeled off in a unit of time is obtained by multiplying the length of the peel off line 53 by an amount of movement of the wiper 33 per unit time. In this case, the force required for the peeling off of the dicing sheet 12 is smaller than the force required when peeling a large portion of the semiconductor die 15 at once. Thus, it is advantageously possible to reduce the force exerted to the semiconductor die 15 when peeling the dicing sheet 12.

Further, in this embodiment, because the suction window 41 in the direction to which the wiper 33 is moved is blocked by the shutter 23, the air does not enter into the housing 21 of the vacuum state through the suction window 41 that is blocked by the shutter 23, and even when a gap is formed between the shutter 23 and the dicing sheet 12 due to the semiconductor die 15 pushed up by the tip end 33b of the wiper 33, the air in the gap is not suctioned into the suction window 41. As a result, a portion of the semiconductor die 15 in the direction to which the wiper 33 is moved from the tip end 33b of the wiper 33 is not suctioned into the suction window 41, and thus a possibility of, for example, deformation in the die due to the suction force is reduced

Further, in this embodiment, a part of the suction window 41 in the direction to which the wiper 33 is moved is blocked by the shutter 23. Accordingly, even when there are semiconductor dies that are adjacent to the semiconductor die 15 to be picked up in the direction to which the wiper 33 is moved, the semiconductor die 15 to be picked up can be picked up without applying any force to the adjacent semiconductor dies. Thus, it is advantageously possible to pick up the semiconductor die 15 easily even when there are semiconductor dies 15 near the semiconductor die to be picked up.

Furthermore, in this embodiment, by way of controlling the moving speed of the wiper 33, it is possible to set the force exerted to the semiconductor die 15 during the peeling off of the dicing sheet 12 to be a suitable amount. For example, in a case in which semiconductor dies to be picked up are thin in thickness and low in strength, it is possible to easily peel off the dicing sheet by reducing the force exerted to the semiconductor dies with a weaker peeling force produced by decreasing the moving speed of the wiper 33 to reduce the amount of peeling per time unit to produce or a reduced suction force acting through the suction opening 42. Alternatively, in a case in which the semiconductor dies are thick and strong, it is possible to reduce the time required for the peeling off by increasing the moving speed of the wiper 33 to increase the area of peeling per unit time. In this case, a thickness detection unit such as a thickness sensor can be provided for detecting the thickness of the semiconductor die to be picked up and outputs data of the detected thickness to the control unit 70. It is also possible to configure that the moving speed of the cover plate can be changed according to the thickness of the semiconductor dies detected by the thickness detection unit. In this case, the moving speed can be determined based on a map of the moving speed to the thickness of the semiconductor dies that is stored in a memory unit within the control unit 70. Further, in a case in which the drive unit 25 is driven by, for example, a motor, the control unit 70 can change the revolutions of the motor to change the moving speed of the wiper 33, or in a case in which the drive unit 25 is configured to realize the back and forth movement of the first link member 26 by the electromagnetic force, the control unit 70 can change the pulse of the electromagnetic force and an interval between the pulses to change the speed of the movement of the first link member 26.

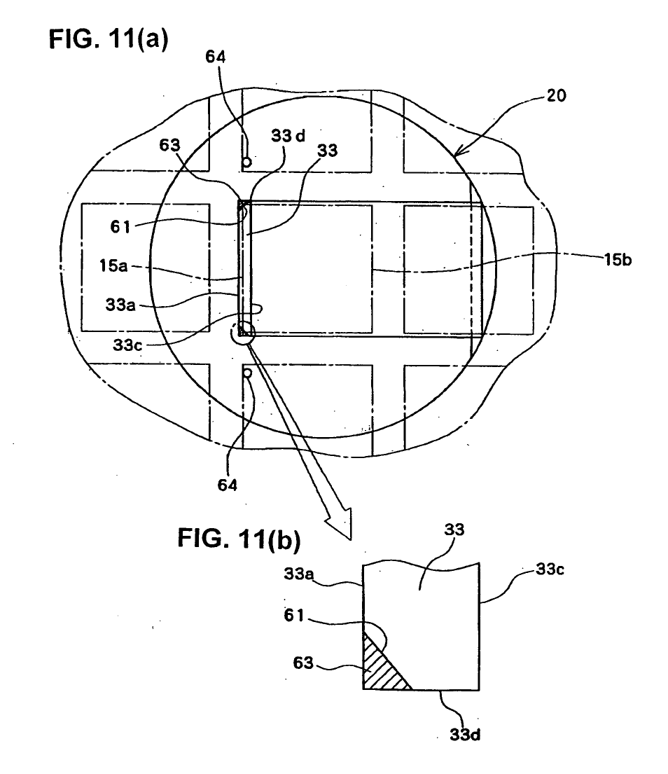

Referring to FIGS. 11(a) and 11(b), a different embodiment according to the present invention will be described below. The like components as in the embodiment described with reference to FIG. 1 through FIG. 10(b) are designated by the like numerals and will not be explained.

In this embodiment of FIGS. 11(a) and 11(b) a notch 61 is provided at each corner between the seat surface 33a and a side surface 33d of the wiper 33. As shown in FIG. 11(b), with the presence of the notch 61, a notch hole 63 that opens into the housing 21 is formed immediately below each corner at the first end 15a side of the semiconductor die 15 to be picked up when the suction opening 42 is closed upon the seat surface 33a of the wiper 33 being brought into contact with the first end surface 41a of the suction window 41. Further, in this embodiment, as shown in FIG. 11(a), the adherence surface 22 around the suction window 41 is formed with suction holes 64 that communicates with the interior of the housing 21.

In this embodiment, when the control unit 70 activates the vacuum apparatus 71 to evacuate the interior of the housing 21 to produce a vacuum therein, even when the suction opening 42 is in the closed state such that the seat surface 33a of the wiper 33 is in contact with the first end surface 41a of the suction window, it is possible to suction the dicing sheet 12 at the corners of the first end 15a of the semiconductor die 15 through the notch holes 63 and peels the dicing sheet 12 at these corners first. Then, as in the previously explained embodiment, the seat surface 33a of the wiper 33 is moved toward the direction away from the first end surface 41a of the suction window 41, and the dicing sheet 12 is sequentially peeled off from the first end 15a of the semiconductor die 15. At this time, because the dicing sheet 12 near the first end surface 41a of the suction window 41 is vacuum suctioned by the adherence surface 22 through the suction holes 64 around the suction window 41, it is possible to prevent the dicing sheet 12 near the suction opening 42 from going upward due to the tip end 33b of the wiper 33 when the wiper 33 is moved to open the suction opening 42 and the semiconductor die 15 to be picked up is pushed up by the tip end 33b of the wiper 33. Thus, it is advantageously possible to make the tensile force exerted to the dicing sheet 12 downward large and to peel the dicing sheet 12 off from the semiconductor die 15 to be picked up more easily.

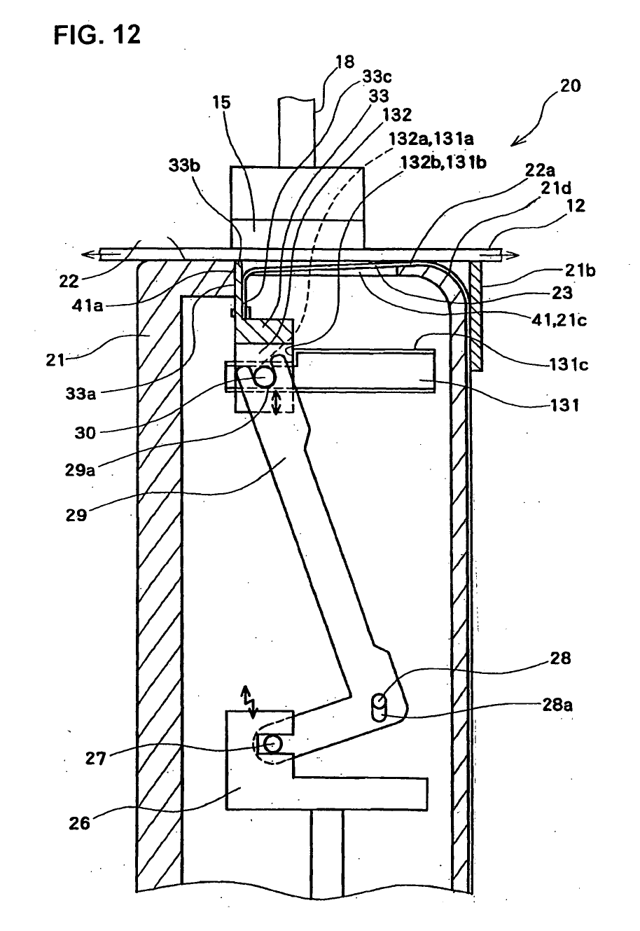

FIG. 12 shows a further different embodiment according to the present invention. The like components as in the embodiment described with reference to FIG. 1 through FIG. 10(b) are designated by the like numerals and will not be explained.

In this embodiment of FIG. 12, a guide rail 131 is provided within the die stage 20, and it includes a stopper surface 131a along the adherence surface 22, a first sliding surface 131b in the direction away from the adherence surface 22, and a second sliding surface 131c along the adherence surface 22. Further, a second link member 129 is formed with an elongate hole 28a with which the second link member 129 can move along the first sliding surface 131b by a length of the first sliding surface 131b.

Further, a slider 132 is provided in the wiper 33 so that it is in contact with the stopper surface 131a of the guide rail 131, and this slider 132 has a bottom surface 132a that slides along the second sliding surface 131c of the guide rail 131 and a side surface 132b that slides along the first sliding surface 131b of the guide rail 131.

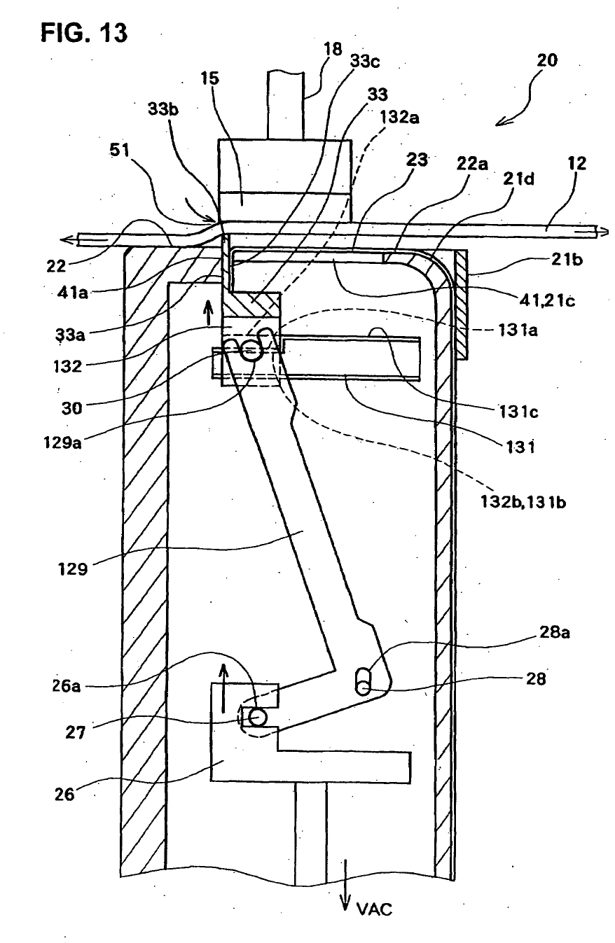

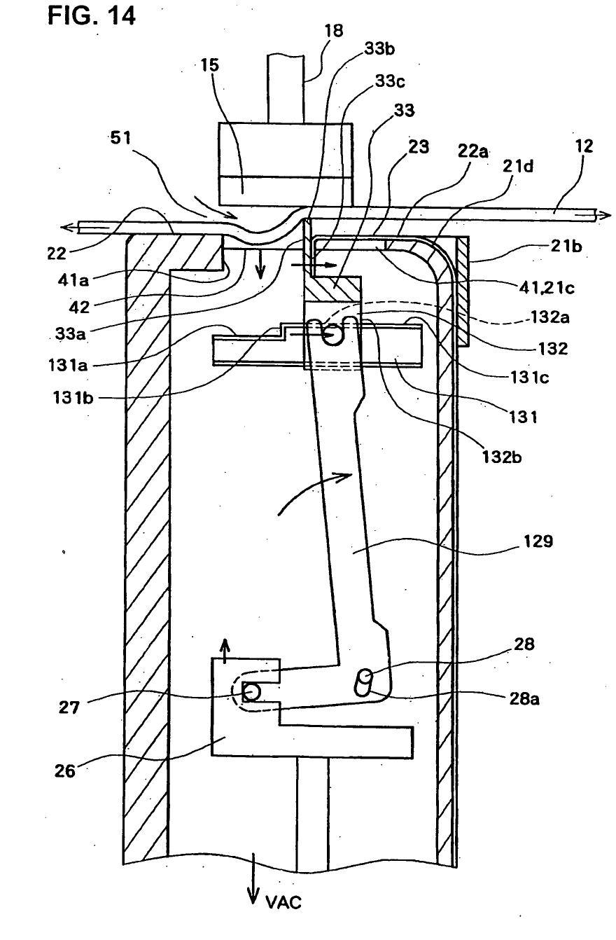

The operation according to this embodiment will be now described with reference to FIG. 13 and FIG. 14. As in the previously explained embodiment with reference to FIG. 6, the control unit 70 performs the die positioning so that the adherence surface 22 and the tip end 33b of the wiper 33 are closely in contact with the lower surface of the dicing sheet 12, and the linear tip end 33b of the wiper 33 is aligned with the first end 15a of the semiconductor die 15 to be picked up. Then, upon completion of the positioning step, the control unit 70 starts the dicing sheet peeling step.

More specifically, as shown in FIG. 13, the control unit 70 first operates the drive unit 25. In this operation, when the first link member 26 is moved upward toward the adherence surface 22, the pin 27 provided on the first end of the second link member 129 fitted in the engaging groove 26a of the first link member 26 is moved upward together with the engaging groove 26a. The engaging groove 129a provided on the second end of the second link member 129 is engaged with the pin 30 fixed to the slider 132, the bottom surface 132a of the slider 132 is in contact with the stopper surface 131a of the guide rail 131, and the side surface 132b of the slider 132 is in contact with the first sliding surface 131b of the guide rail 131. The first sliding surface 131b of the guide rail 131 guides the slider 132 in the direction away from the adherence surface 22 and restricts the movement of the slider 132 along the adherence surface 22 when the side surface 132b of the slider 132 is in contact with the first sliding surface 131b of the guide rail 131. The U-shaped engaging groove 129a of the second end of the second link member 129 is fitted in the pin 30 fixed to the slider 132, and the slider 132 cannot move along the adherence surface 22 when the side surface 132b of the slider 132 is in contact with the first sliding surface 131b of the guide rail 131. Accordingly, even when the pin 27 is moved upward by the upward movement of the first link member 26, the second link member 129 cannot rotate about the pin 28. On the other hand, since the second link member 129 includes the elongate hole 28a with which the second link member 129 is movable along the first sliding surface 131b by the length of the first sliding surface 131b, with the upward movement of the first link member 26, the second link member 129 is moved upward toward the adherence surface 22 instead of rotating pushes up the U-shaped engaging groove 129a on the second end. With this movement, the pin 30 that is fitted in and in contact with the engaging groove 129a is pushed up, the bottom surface 132a of the slider 132 is moved away form the stopper surface 131a of the guide rail, and the side surface 132b of the slider 132 is moved upward toward the adherence surface 22 along the first sliding surface 131b of the guide rail 131.

When the slider 132 is moved upward toward the adherence surface 22, the wiper 33 attached to the slider 132 is also moved upward such that the seat surface 33a of the wiper 33 is moved along the first end surface 41a of the suction window 41, and the tip end 33b of the wiper 33 protrudes from the adherence surface 22 to push the first end 15a of the semiconductor die 15 upward. Because the dicing sheet 12 is being pulled toward the outer circumference, an obliquely downward force is exerted to the dicing sheet 12 due to the tensile force when pushed up by the semiconductor die 15. By a downward component force of this obliquely downward force, the dicing sheet 12 on the first end 15a side of the semiconductor die 15 is pulled downward, and by this tensile force, the dicing sheet 12 on the first end 15a of the semiconductor die 15 is peeled from the semiconductor die 15. Then, the gap 51 is formed between the semiconductor die 15 and the dicing sheet 12, and the air enters into the gap 51.

When the bottom surface 132a of the slider 132 is moved up to the level of the second sliding surface 131c the guide rail 131, the side surface 132b of the slider 132 is not in contact with the first sliding surface 131b of the guide rail 131, and the slider 132 is allowed to move along the adherence surface 22. Further, the elongate hole 28a of the second link member has the same length as the first sliding surface 131b of the guide rail 131; accordingly, when the slider 132 is moved upward toward the adherence surface 22 by the length of the first sliding surface 131b of the guide rail 131, the cylindrically shaped inner surface on the lower portion of the elongate hole 28a is brought into contact with the outer surface of the pin 28 having a cylindrical shape.

As shown in FIG. 14, when the first link member 26 is further moved upward toward the adherence surface 22 in this state, the second link member 129 is rotated about the pin 28, and with this rotary movement, the slider 132 is moved toward the direction away from the first end surface 41a of the suction window 41 so that the bottom surface 132a corresponds to the second sliding surface 131c the guide rail 131.

Then, the seat surface 33a of the wiper 33 attached to the slider 132 is moved toward the direction away from the first end surface 41a of the suction window 41 with the tip end 33b of the wiper 33 protruding from the adherence surface 22, and the suction opening 42 that communicates with the interior of the housing 21 in the vacuum state opens between the seat surface 33a and the suction window 41. Once the suction opening 42 is opened, a pressure difference between the gap 51 and the suction opening 42 causes the dicing sheet 12 to be suctioned into the suction opening 42, as a result, the dicing sheet 12 is peeled off from the semiconductor dies 15. Further, the shutter 23 attached to the moving side surface 33c of the wiper 33 is moved along with the wiper 33 while blocking the suction window 41.

Then, as explained with respect to FIG. 9, when the tip end 33b of the wiper 33 is moved to a position passed the second end 15b of the semiconductor dies 15, the dicing sheet 12 of the second end 15b is suctioned into the suction opening 42 and peeled off from the semiconductor die 15, and the air comes into between the semiconductor dies 15 and the dicing sheet 12 from the second end 15b side. Thus, the semiconductor die 15 is completely removed from the dicing sheet 12.

In this embodiment, a trigger for peeling off of the dicing sheet 12 is made by having the tip end 33b of the wiper 33 protrude to form the gap 51 between the semiconductor die 15 and the dicing sheet 12 by the downward tensile force exerted to the dicing sheet 12, and then the wiper 33 is moved to open the suction opening 42 so that the dicing sheet 12 is suctioned into the suction opening 42. Thus, it is advantageously possible to peel off the dicing sheet 12 more easily.

In the above-described embodiment, the wiper 33 is moved along the adherence surface 22 after the tip end 33b of the wiper 33 is protruded from (or protruded higher than) the adherence surface 22 by the first sliding surface 131b in the direction away from the adherence surface 22 and the second sliding surface 131c along the adherence surface 22 provided for the guide rail 131, the side surface 132b and the bottom surface 132a of the slider that are respectively moved along the sliding surfaces 131b and 131c, and the elongate hole 28a with which the second link member 129 is allowed to move up and down in the direction closer to and away from the adherence surface 22. However, the present invention is not limited to such a configuration as long as the wiper 33 is moved along the adherence surface 22 after the tip end 33b of the wiper 33 is protruded from the adherence surface 22. For example, a plurality of cam surfaces can be combined, or the slider 132 can be provided with a roller that rotates in contact with the bottom surface 132a and the side surface 132b of the slider 132.

Further, in this embodiment as well, as in the embodiment described with reference to FIG. 11, the suction hole(s) 64 can be provided in the adherence surface 22 around the tip end 33b of the wiper 33 so as to increase the downward tensile force exerted to the dicing sheet 12 when the semiconductor die 15 is pushed up by the tip end 33b of the wiper 33.

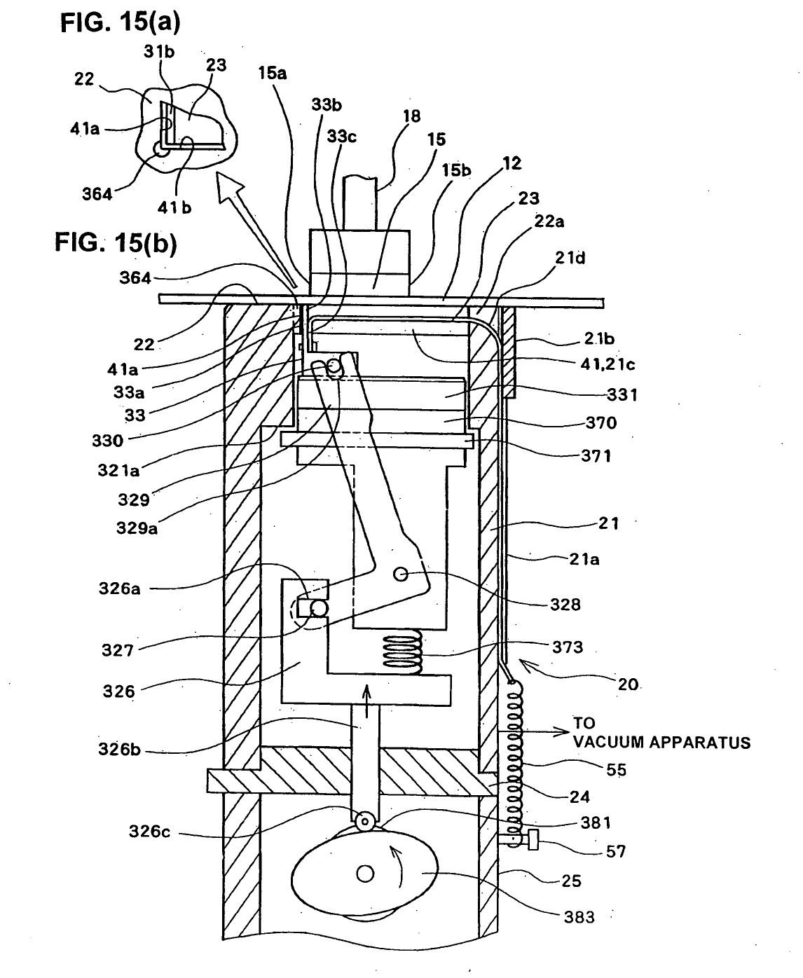

A further different embodiment according to the present invention will be described with reference to FIG. 15(a) through FIG. 17. The like components as in the embodiment described with reference to FIG. 1 through FIG. 15 are designated by the like numerals and will not be explained.

As shown in FIG. 15(b), in this embodiment as in the embodiment previously described with reference to FIG. 4, the wiper moving mechanism for moving the wiper 33 is provided within the die stage 20. The wiper moving mechanism is comprised of: a first link member 326 driven by the drive unit 25, which is provided on the base body 24 of the die stage 20, in the direction closer to and away from the adherence surface 22; a piston 370 that is slidably provided in the housing 21 of the die stage 20 and moves closer to and away from the adherence surface 22; a stopper 321a that is provided within the housing 21 and engaged with a flange 371 of the piston 370 to restrict the movement of the piston 370 in the direction closer to and away from the adherence surface 22; a spring 373 that connects the first link member 326 and the piston 370 in the direction closer to and away from the adherence surface; a guide rail 331 that is provided on the piston 370 and extends in the direction that is parallel with the adherence surface 22 and in which the suction window 41 extends; the wiper 33 slidably mounted to the guide rail 331; and a second link member 329 that is rotatably attached to the piston 370 via a pin 328, connects the wiper 33 to the first link member 326, and converts the movement of the first link member 326 in the direction closer to and away from the adherence surface 22 into the movement in the direction along the guide rail 331 of the wiper 33 when the piston 370 is brought into contact with the stopper 321a. Further, the housing 21 is connected to the vacuum apparatus 71 shown in FIG. 4 so that the vacuum is produced therein.

The second link member 329 connects the wiper 33 to the first link member 326 by a pin 327 provided on the first end of the second link member 329 and fitted in an engagement groove 326a of the first link member 326 and by an engagement groove 329a provided on the second end of the second link member 329 and sandwiching a pin 330 of the wiper 33. A motor 381 for operating the wiper moving mechanism is provided within the drive unit 25, and a cam 383 that is in contact with a roller 326c provided on a tip end of a shaft 326b of the first link member 326 is attached to the rotary shaft of the motor 381.

FIG. 15(a), a top view, shows a flat surface of the adherence surface 22 at the corner of the suction window 41. As shown in FIG. 15(a), in this embodiment, a suction hole 364 is formed at the corner (or at each one of the corners) between the first end surface 41a and the side surface 41b of the suction window 41. The suction holes 364 protrude toward the outside of the suction window 41 and penetrate through the adherence surface. The suction holes 364 communicate with the interior of the housing 21 even when the cover plate 23 is closed.

The operation according to this embodiment will be described below. As in the embodiment described with reference to FIGS. 6(a) and 6(b), the control unit 70 starts the positioning step. When the die positioning step starts, the seat surface 33a of the wiper 33 provided in the die stage 20 is in contact with the first end surface 41a of the suction window 41, and the tip end 33b of the wiper 33 is in the same plane as the adherence surface 22. Further, the shutter 23 that is attached to the moving side surface 33c of the wiper 33 with a die stage from (or so as to be lower than) the tip end 33b of the wiper 33 blocks the suction window 41 that is in the moving direction of the wiper 33. The shutter 23 is as wide as the suction window 41, and the surface of a side of the shutter 23 connected to the moving side surface 33c is lower than the adherence surface 22, and the surface of the shutter retainer 21 side is fitted in the groove 22a having the same width as the suction window 41 and also lower than the adherence surface 22, and the shutter 23 is substantially parallel with the adherence surface. Further, the shutter 23 is flexed toward a direction away from the adherence surface 22 from the groove 22a along the curved surface 21d and guided by the groove 21a of the die stage 20 and pulled downward by the spring 55.

Upon completion of the die positioning step, the semiconductor die 15 is at a position at which the first end 15a of the semiconductor die 15 aligns with the linear tip end 33b of the wiper 33, and side surfaces of the semiconductor die 15 align with the side surfaces 23b of the shutter 23, respectively. Further, the second end 15b of the semiconductor die 15 is at a position on the shutter 23.

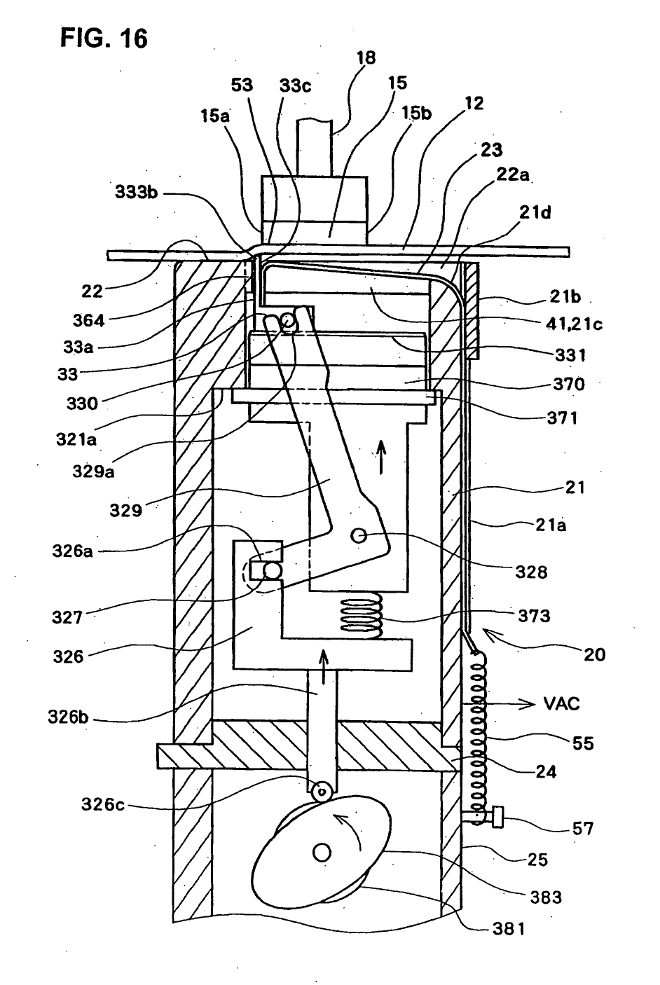

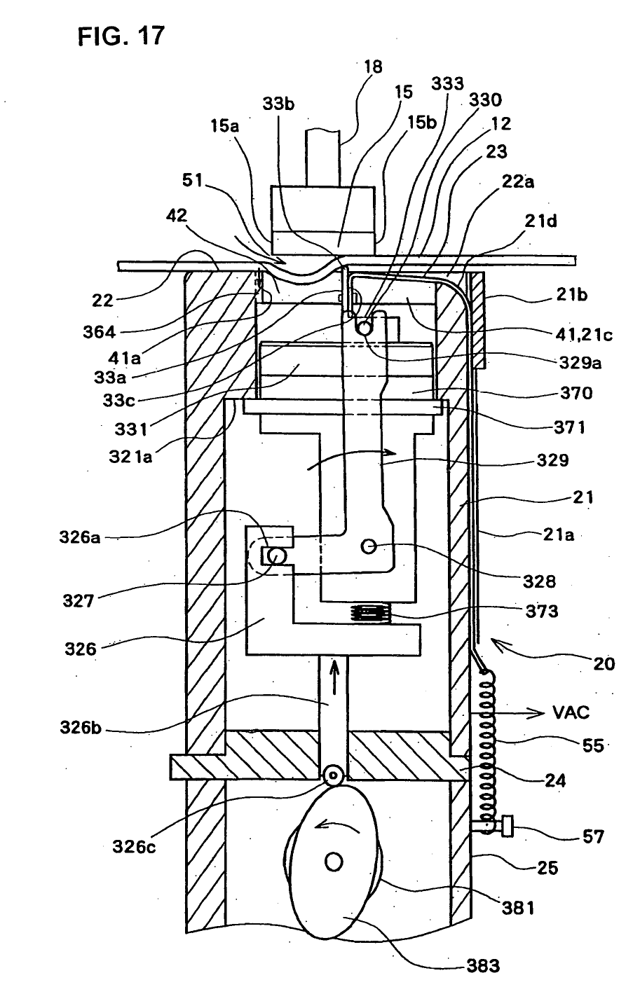

FIG. 16 through FIG. 17 show the dicing sheet peeling step. As shown in FIG. 16, at the start of the dicing sheet peeling step, the control unit 70 evacuates the interior of the housing 21 of the die stage 20 to produce a vacuum there using the vacuum apparatus 71 shown in FIG. 4. Then, the control unit 70 moves the first link member 326 to protrude toward the adherence surface 22 using the drive unit 25. The operation of the wiper moving mechanism realized by the drive unit 25 will be described below.

As shown in FIG. 16, when the motor 381 of the drive unit 25 rotates according to the instruction from the control unit, the cam 383 attached to the shaft of the motor 381 rotates. The cam 383 has an ellipse shape, and its cam surface is in contact with the roller 326c provided at the tip end of the shaft 326b of the first link member 326; accordingly, when the cam 383 is rotated in a direction indicated by an arrow shown in FIG. 16, the cam surface of the cam 383 pushes the roller 326c up toward the adherence surface 22. By this movement, the shaft 326b goes upward, and an entirety of the first link member 326 is raised toward the adherence surface 22. When the entire first link member 326 is raised, the piston 370 connected to the first link member 326 on the adherence surface 22 side via the spring 373 is pushed up by the first link member 326, and the piston 370 is entirely raised toward the adherence surface 22. When the entire piston 370 is raised toward the adherence surface 22, the guide rail 331 attached to the piston 370 on the adherence surface 22 side is also raised along with the piston 370 toward the adherence surface 22. When the guide rail 331 is raised, the wiper 33 that is attached so as to slide along the upper surface of the guide rail 331 is also raised toward the adherence surface 22, and as the wiper 33 is raised, the tip end 33b of the wiper 33 protrudes upward from the adherence surface 22.

The spring 373 has a sufficient rigidity such that it hardly flexes by the force that pushes the tip end 33b of the wiper 33 up from (or higher than) the adherence surface 22, and accordingly, the distance between the piston 370 and the first link member 326 practically does not change even if the tip end 33b of the wiper 33 is pushed up from the adherence surface 22. As a result, by the rise of the first link member 326, the tip end 33b of the wiper 33 protrudes from the adherence surface 22 but the wiper 33 does not slide.

When the tip end 33b of the wiper 33 protrudes from the adherence surface, the tip end 33b of the wiper 33 pushes the semiconductor die 15 upward. On the other hand, the suction holes 364 are provided at the corners between the first end surface 41a and the side surfaces 41b of the suction window 41, and the dicing sheet 12 near the first end 15a of the semiconductor die 15 to be picked up is suctioned and fixed to the adherence surface 22. Therefore, with the rise of the tip end 33b of the wiper 33, the dicing sheet 12 attached to the semiconductor die 15 is pulled toward the adherence surface 22 obliquely downward, and the tensile force of the dicing sheet 12 obliquely downward produces a gap between the first end 15a of the semiconductor die 15 and the dicing sheet 12. Then, the air comes into the gap, and the downward tensile force and a pressure difference between the air and the vacuum inside the housing 21 causes the dicing sheet 12 to start to be peeled off from the first end 15a of the semiconductor die 15. The dicing sheet 12 extends from the first end 15a of the semiconductor die 15 to the peel off line 53 that is slightly off from the first end 15a along the sliding direction of the wiper 33.

Further, while the end of the shutter 23 attached to the moving side surface 33c of the wiper is also moved up toward the adherence surface 22 by the rise of the wiper 33, the wiper 23 inclines toward the moving side surface 33c of the wiper because the side of the shutter 23 facing outside the die stage is guided by the groove 22a that is lower than the adherence surface 22. However, the shutter 23 is moved upward within the thickness of the upper plate 21c of the die stage 20, and either of the side surfaces 23b of the shutter 23 does not protrude from the adherence surface 22, and it blocks the suction window 41 on the moving side surface 33c side of the wiper 33.

Then, as the motor 381 is further rotated by the control unit 70, and as the first link member 326 and the piston 370 are raised toward the adherence surface 22 by the cam 383 that is rotated by the motor, the end surface of the flange 371 that extends outwardly from the piston 370 is brought into contact with the stopper 321a provided in the housing 21. As a result, the piston 370 cannot move any further toward the adherence surface 22 due to the stopper 321a, and the protrusion of the tip end 33b from the adherence surface 22 is also stopped.

As shown in FIG. 17, when the cam 383 is further rotated and the first link member 326 is pushed up toward the adherence surface 22, the spring 373 between the piston 370 that cannot move toward the adherence surface 22 and the first link member 326 starts to be compressed by the motor 381 and cam 383 in the direction moving closer to and away from the adherence surface 22. When the spring 373 is compressed, the piston 370 does not move toward the adherence surface 22, and only the first link member 326 is moved toward the adherence surface 22. As a result, the pin 328 of the piston 370 is not raised toward the adherence surface 22, and only the pin 327 of the second link member 329 fitted in the engagement groove 326a of the first link member 326 is raised toward the adherence surface 22. As a result, the second link member 329 starts to rotate about the pin 328. By this rotary movement, the engagement groove 329a on the second end of the second link member 329 is moved toward the outside of the die stage 20, and the wiper 33 to which the pin 330 fitted in the engagement groove 329a is fixed and the shutter 23 attached to the moving side surface 33c of the wiper 33 slide toward the outside of the die stage 20.

As shown in FIG. 17, as the wiper is thus moved, the seat surface 33a is moved toward the direction away from the first end surface 41a of the suction window 41 with the tip end 33b of the wiper 33 protruding from the adherence surface 22, and the suction opening 42 that communicates with the interior of the housing 21 under the vacuum state is opened between the seat surface 33a and the suction window 41. Once the suction opening 42 is opened, a pressure difference between the gap 51 and the suction opening 42 causes the dicing sheet 12 to be suctioned into the suction opening 42, thereby peeling the dicing sheet 12 off from the semiconductor die 15. Further, the shutter 23 attached to the moving side surface 33c of the wiper 33 is moved with the wiper 33 while blocking the suction window 41. Then, the suction opening 42 is covered by the dicing sheet 12 that has been peeled off. However, even if the dicing sheet 12 is suctioned into the suction opening 42 and the suction opening 42 is covered by the dicing sheet 12, since the wiper 33 slides toward a portion where the dicing sheet 12 is not peeled yet, the suctioning of the dicing sheet 12 into the suction opening 42 is not stopped, and it is possible to sequentially suction the entirety of the dicing sheet 12 under the die 15 into the suction opening 42, so that the entire dicing sheet 12 is removed without remaining.

Moreover, when the cam 383 is further rotated, the first link member 326 is further pushed up due to the rotation of the cam 383, and, as in FIG. 9, the tip end 33b of the wiper 33 is moved to a position at which the first end surface 23a of the cover plate 23 reaches a position passed the second end 15b of the semiconductor dies 15. As a result, the dicing sheet 12 of the second end 15b is suctioned into the suction opening 42 and peeled off from the semiconductor die 15, and the air comes into between the semiconductor die 15 and the dicing sheet 12 from the second end 15b side. Thus, the semiconductor die 15 is completely removed from the dicing sheet 12.

After this, the shaft 326b of the first link member 326 is moved down by the rotation of the cam 383 as the cam 383 is further rotated, and by this downward movement, the wiper 33 closes until its seat surface 33a is brought into contact with the first end surface 41a of the suction window 41. As a result, the compressing force exerted to the spring 373 is released. Then, as the cam 383 is further rotated and the shaft 326b is moved down, the piston 370, the first link member 326, and the second link member 329 are together moved downward, and the tip end 33b of the wiper 33 is moved down to the position substantially the same as the surface of the adherence surface 23, thus returning to its initial position.

In this embodiment, the wiper 33 is caused to slide after pushing up the semiconductor die 15 to be picked up by the wiper moving mechanism of the wiper 33 and making a trigger for peeling the dicing sheet 12 to the first end 15a of the semiconductor die 15 to be picked up by the downward tensile force exerted to the dicing sheet 12, and then the dicing sheet 12 is suctioned into the suction opening 42. Thus, it is advantageously possible to peel off the dicing sheet 12 more easily.

What is claimed is:

1. A die pick-up apparatus for picking up semiconductor dies by suctioning and holding a semiconductor die attached to a dicing sheet and picking up the semiconductor die using a collet,
the die pick-up apparatus comprising:
a die stage provided with an adherence surface that is adhered to a first surface of the dicing sheet facing away from a second surface of the dicing sheet to which the semiconductor die is attached;
a wiper having a tip end, which moves in and out of the adherence surface, and a seat surface, which moves toward and away from an end surface of a suction window formed in the adherence surface; and
a shutter that is moved with the wiper while blocking the suction window in a direction in which the wiper is moved, and
the die pick-up apparatus further comprising:
a means for aligning the tip end of the wiper with a first end of the semiconductor die to be picked up,
a means for moving the wiper in a direction in which the seat surface of the wiper moving away from the end surface of the suction window while the tip end of the wiper is protruded from the adherence surface while the semiconductor die to be picked up is being suctioned by the collet, thus sequentially opening a suction opening between the end surface of the suction window and the seat surface of the wiper, and
a means for suctioning the dicing sheet from a first end side of the semiconductor die to be picked up into the suction opening that has been opened,
thereby sequentially peeling off the dicing sheet from the semiconductor die to be picked up.

2. The die pick-up apparatus for picking up semiconductor dies according to claim 1, wherein
the suction window and the wiper have substantially the same width as the semiconductor die to be picked up.

3. The die puck-up apparatus for picking up semiconductor dies according to claim 2, wherein
a notch is formed at a corner of the wiper between the seat surface and a side surface thereof.

4. The die pick-up apparatus for picking up semiconductor dies according to one of claims 1 through 3, wherein
the die stage is provided with a suction hole formed around the suction window in the adherence surface, and
when picking up the semiconductor die, the tip end of the wiper is caused to protrude from the adherence surface and move while a portion of the dicing sheet around the semiconductor die to be picked up is suctioned through the suction hole.

5. The die pick-up apparatus for picking up semiconductor dies according to one of claims 1 through 4, further comprising a wiper moving mechanism for moving the wiper, wherein
the wiper moving mechanism is comprised of:
a drive unit that is attached to a base body of the die stage provided on a side opposite from the adherence surface and drives a first link member provided within the die stage in a direction in which the first link member is moved closer to and away from the adherence surface;
a piston that is provided within the die stage and moved closer to and away from the adherence surface;
a stopper that is provided within the die stage and restricts the movement of the piston moving closer to and away from the adherence surface;
a spring that connects the first link member to the piston in the direction closer to and away from the adherence surface, the spring being compressed when the piston is brought into contact with the stopper;
a guide rail that is attached to the piston and extends in a direction which is substantially in parallel with the adherence surface and in which the suction opening extends, the wiper being slidably provided on the guide rail; and
a second link member that is slidably attached to the piston, connects the wiper to the first link member, and converts a movement of the first link member moving closer to and away from the adherence surface into a movement of the wiper moving along the guide rail when the piston is brought into contact with the stopper, wherein
when picking up the semiconductor die, the wiper is caused to slide along the adherence surface after the tip end of the wiper protrudes from the adherence surface by the first link member moving closer to and away from the adherence surface using the drive unit.

6. The die pick-up apparatus for picking up semiconductor dies according to one of claims 1 through 4, further comprising a wiper moving mechanism for moving the wiper, wherein
the wiper moving mechanism is comprised of:
a drive unit that is attached to a base body of the die stage provided on a side opposite from the adherence surface and drives a first link member provided within the die stage in a direction that the first link member is moved closer to and away from the adherence surface;
a guide rail that is provided within the die stage and is formed with an inclined surface that inclines toward the adherence surface;
a slider to which the wiper is connected and which is slidably provided on the inclined surface of the guide rail; and
a second link member that is slidably provided within the die stage, connects the slider to the first link member, and converts a movement of the first link member moving closer to and away from the adherence surface into a movement of the slider moving along the inclined surface of the guide rail, and wherein
when picking up the semiconductor die, the wiper is caused to slide along the adherence surface while the tip end of the wiper protrudes from the adherence surface by the first link member moving closer to the adherence surface using the drive unit.

7. The die pick-up apparatus for picking up semiconductor dies according to one of claims 1 through 4, further comprising wiper moving mechanism for moving the wiper, wherein
the wiper moving mechanism is comprised of:
a drive unit that is attached to a base body of the die stage provided on a side opposite from the adherence surface and drives a first link member provided within the die stage in a direction in which the first link member is moved closer to and away from the adherence surface;
a guide rail that is provided within the die stage and is formed with a first sliding surface in a direction facing away from the adherence surface and a second sliding surface in a direction facing toward the adherence surface;
a slider to which the wiper is connected and which is provided to be slidable in each direction along each sliding surface of the guide rail; and
a second link member that is slidably provided within the die stage via an elongate hole that extends by a length of a first sliding surface thereof in the direction closer to and away from the adherence surface, and converts a movement of the first link member moving closer to and away from the adherence surface into a movement along each sliding surface, and wherein
when picking up the semiconductor die, the wiper is caused to slide along the adherence surface while the tip end of the wiper protrudes from the adherence surface by the first link member moving closer to the adherence surface using the drive unit.

8. A method for picking up semiconductor dies attached to a dicing sheet using a die pick-up apparatus comprising:
a die stage provided with an adherence surface that is adhered to a first surface of the dicing sheet facing away from a second surface of the dicing sheet to which a semiconductor die to be picked up is attached;
a wiper having a tip end that moves in and out of the adherence surface and a seat surface that moves away from an end surface of a suction window formed in the adherence surface;
a shutter that is moved with the wiper while blocking the suction window in a direction in which the wiper is moved; and
a collet for picking up the semiconductor die,
the method comprising:
a positioning step in which the tip end of the wiper is aligned with a first end of the semiconductor die to be picked up; and
a dicing sheet peeling step in which
the wiper is moved in a direction in which the seat surface of the wiper is moved away from the end surface of the suction window while the tip end of the wiper is protruded from the adherence surface in a state in which the semiconductor die to be picked up is suctioned by the collet,
a suction opening is sequentially opened between the end surface of the suction widow and the seat surface of the wiper, and
the dicing sheet is suctioned from a first end side of the semiconductor die to be picked up into the suction opening that has been opened,
thereby sequentially peeling off the dicing sheet from the semiconductor die to be picked up.
